(19) United States
(12) Patent Application Publication
(10) Pub. No.: US 2026/0225405 A1
(43) Pub. Date: Aug. 6, 2026

(54) PNEUMATIC TIRE

(71) Applicant: TOYO TIRE CORPORATION, Itami-shi (JP)

(72) Inventor: Tsuyoshi FUJIOKA, Itami-shi (JP)

(73) Assignee: TOYO TIRE CORPORATION, Itami-shi (JP)

(21) Appl. No.: 19/444,975

(22) Filed: Jan. 9, 2026

(30) Foreign Application Priority Data
Jan. 31, 2025 (JP) 2025-015710
Feb. 5, 2025 (JP) 2025-017896

(51) Int. Cl. B60C 11/03; B60C 11/12

(52) U.S. Cl. CPC B60C 11/0309; B60C 11/125; B60C 2011/0346; B60C 2200/06

(57) ABSTRACT

A pneumatic tire capable of generating sufficient traction and achieving satisfactory uneven wear resistance. The pneumatic tire includes: a center main groove provided over an entire circumference in a circumferential direction; a first shoulder main groove and a second shoulder main groove disposed so as to sandwich the center main groove therebetween in an axial direction and provided over the entire circumference in the circumferential direction; and block lines provided between the first shoulder main groove and the second shoulder main groove and extending in the circumferential direction. The block lines respectively include the blocks arranged in the circumferential direction. For the new pneumatic tire, a ratio of a total sum of traction element lengths to a total sum of block areas of the blocks is 4.5% or more and 10.0% or less.

### CROSS REFERENCE TO RELATED APPLICATIONS

This application is based on and claims the benefit of priority from Japanese Patent Application Nos. 2025-015710 and 2025-017896, respectively filed on 31 Jan. 2025 and 5 Feb. 2025, the content of which is incorporated herein by reference.

### FIELD

The present invention relates to a pneumatic tire, and more particularly, to a pneumatic tire suitable for a heavy vehicle, such as a bus, a truck, and the like. Related Art

An example of known pneumatic tires is disclosed in Japanese Unexamined Patent Application, Publication No. 2012-51502. This pneumatic tire includes a center main groove, a pair of shoulder main grooves disposed so as to sandwich the center main groove in the axial direction and extending over the entire circumference in the circumferential direction, and a circumferential groove disposed between the center main groove and each shoulder main groove in the axial direction and extending over the entire circumference in the circumferential direction.

The pneumatic tire further includes, in a land region between the center main groove and one of the shoulder main grooves and a land region between the center main groove and the other of the shoulder main grooves, a plurality of first axial grooves that communicate with both the circumferential groove and the center main groove and are arranged at intervals in the circumferential direction, and a plurality of second axial grooves that communicate with both the circumferential groove and the shoulder main groove and are arranged at intervals in the circumferential direction.

### SUMMARY

In general, in a case where a groove pattern for enhancing traction is employed, the tire rigidity decreases and uneven wear is likely to occur. On the other hand, in a case where the widths of grooves are reduced or the number of grooves is reduced, the rigidity increases and the uneven wear resistance is improved, but the traction performance deteriorates. That is, the improvement in traction performance and the improvement in uneven wear resistance are in a trade-off relationship with each other.

An object of the present invention is to provide a pneumatic tire that generates sufficient traction and has satisfactory uneven wear resistance by appropriately balancing improvement in traction performance and improvement in uneven wear resistance.

An embodiment of the present invention is directed to a pneumatic tire including:
a center main groove provided over an entire circumference in a circumferential direction;
a first shoulder main groove and a second shoulder main groove disposed so as to sandwich the center main groove therebetween in an axial direction and provided over the entire circumference in the circumferential direction; and
a plurality of block lines disposed between the first shoulder main groove and the second shoulder main groove and extending in the circumferential direction. Each of the plurality of block lines includes a plurality of blocks arranged in the circumferential direction. In a state where the pneumatic tire is new, a ratio of a total sum of traction element lengths to a total sum of block areas of the plurality of blocks is 4.5% or more and 10.0% or less.

The present invention provides a pneumatic tire that generates sufficient traction and has satisfactory uneven wear resistance by appropriately balancing improvement in traction performance and improvement in uneven wear resistance.

### BRIEF DESCRIPTION OF THE DRAWINGS

FIG. 1 is a perspective view of a part cut out in an axial direction from a pneumatic tire according to an embodiment of the present invention, as viewed obliquely from above;

FIG. 2 is a plan view illustrating a part of a developed view of an outer circumferential surface of the tire developed in a belt shape;

FIG. 3 is a partially enlarged view of FIG. 2;

FIG. 4 is a plan view of a first block and a second block;

FIG. 5 is a plan view of a fifth block and a sixth block;

FIG. 6 is an enlarged perspective view of a peripheral region of one second slit in the tire, as viewed obliquely from above;

FIG. 7 is a schematic cross-sectional view of a peripheral region of one second slit in the tire, taken along a plane substantially orthogonal to an extending direction of the second slit;

FIG. 8 is a partial plan view of FIG. 3;

FIG. 9 is a diagram illustrating a cross-sectional structure of grooves surrounded by open ellipses in FIG. 8;

FIG. 10 is a schematic diagram illustrating changes in slits and sipes when tire is worn;

FIG. 11 is a schematic diagram illustrating changes in slits and sipes when tire is worn; and

FIG. 12 is a plan view corresponding to FIG. 2 and illustrates a pneumatic tire of another embodiment.

### DETAILED DESCRIPTION OF THE EMBODIMENTS

### Basic Structure of Pneumatic Tire

Embodiments of the present invention will be described below in detail with reference to the accompanying drawings. In the following embodiments, the same components are denoted by the same reference signs in the drawings, and redundant description is omitted. The drawings include schematic diagrams, and dimensional ratios of vertical and horizontal dimensions, height, etc. of each component are not necessarily the same in different drawings. Further, in the pneumatic tire 1 described below, the left and right halves with a center main groove 11 as a boundary have the same structure. However, the left and right halves of the pneumatic tire with the center main groove 11 as a boundary may have different structures. The dimensions of the grooves described below are those of a new pneumatic tire 1 that is free of wear.

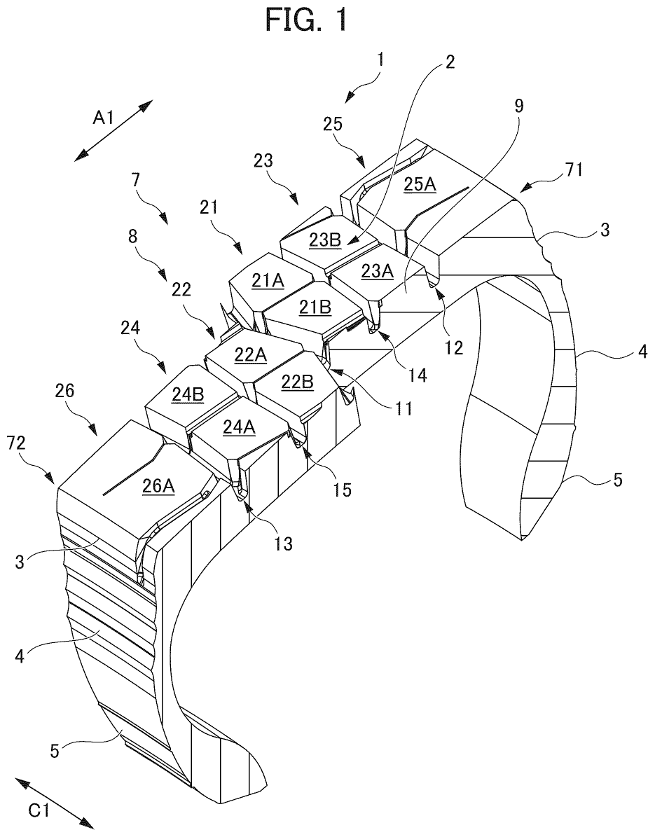

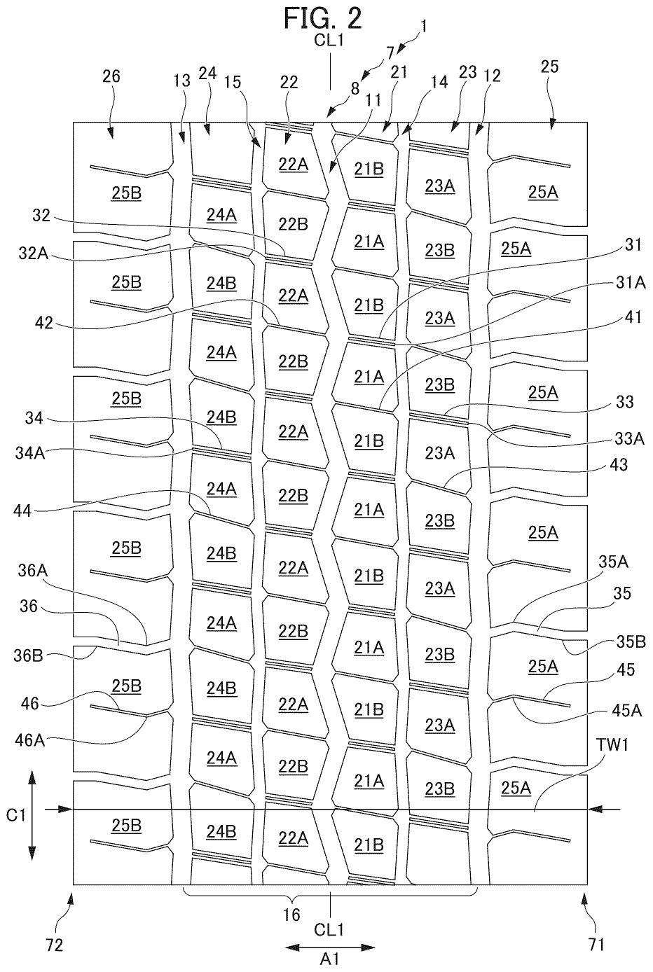

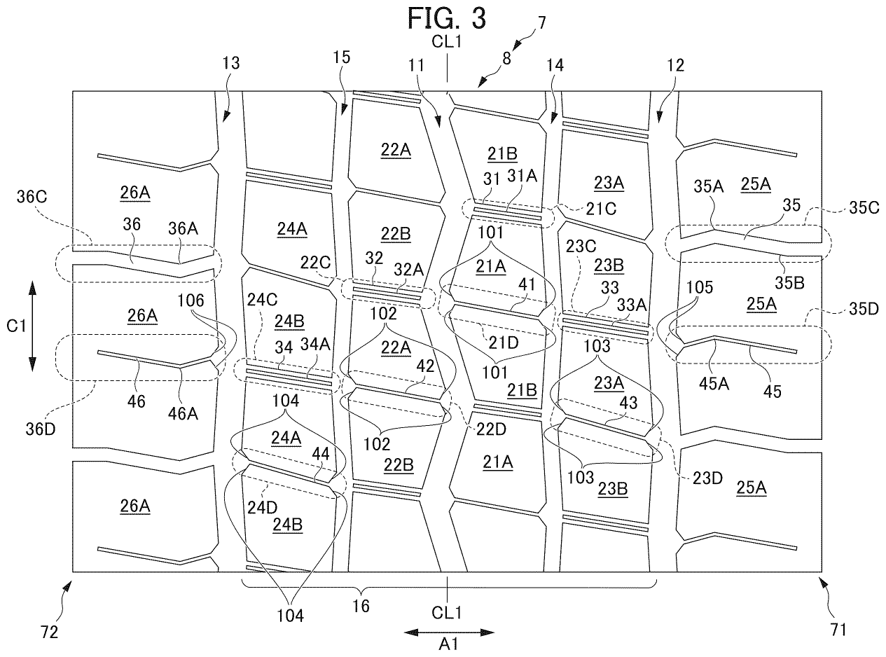

A basic structure of the pneumatic tire 1 (hereinafter simply referred to as the tire 1) will be described with reference to FIGS. 1 to 3. FIG. 1 is a perspective view of a part cut out in an axial direction from the pneumatic tire 1 according to an embodiment of the present invention, as viewed obliquely from above. FIG. 2 is a plan view illustrating a part of a developed view of an outer circumferential surface of the tire 1 developed in a belt shape. FIG. 3 is a partially enlarged view of FIG. 2.

The tire 1 is a heavy load-carrying tire that is fitted to a heavy vehicle, such as a truck, a bus, and the like. The tire 1 has a general configuration that is employed to pneumatic tires. Specifically, the tire 1 includes a tread 2, shoulders 3, sidewalls 4, and beads 5. The tread 2 includes a tread surface 7 that comes into direct contact with a road surface, and the tread surface 7 has a tread pattern 8 engraved therein. In the following, the positional relationships of components is described using an “axial direction A1” and a “circumferential direction C1”. The axial direction A1 is along a rotation axis of the tire 1 and coincides with a width direction of the tire. The circumferential direction C1 is along a rotation direction of the tire 1. In the following description, the “width” of a groove refers to the maximum width of the groove.

The shoulders 3 are a pair of shoulder portions located outward of the tread 2 in the axial direction A1, and the sidewalls 4 are located inward of the shoulders 3 in a radial direction. Each bead 5 includes a bead core and a bead filler, and has a structure in which high-carbon steel wires are bundled, for example. The aforementioned tread surface 7 is a surface that comes into contact with a flat road surface when a normal load is applied to the tire in a state of being fitted on a regular rim, filled to a regular internal pressure, and placed perpendicularly to the flat road surface. The tread surface 7 has a first ground contact end 71 and a second ground contact end 72, which are disposed at outermost positions in the axial direction A1.

The tread 2, the shoulders 3, and the sidewalls 4 protect a carcass (not shown) stretched from the bead 5 on one side to the bead 5 on the other side in the axial direction A1. The beads 5 play a role of fixing opposite ends of the carcass and fixing the tire 1 to the rim. A belt (not shown) is provided on a radially outer side of the carcass, and a tread rubber 9 (a rubber layer that comes into contact with the road surface) is provided on a radially outer side of the belt. An inner liner (not shown) is provided inward of the carcass.

As illustrated in FIGS. 1 to 3, the tire 1 includes a center main groove 11 that is provided in a center portion in the axial direction A1 of the tread surface 7 and extends over the entire circumference in the circumferential direction C1, and a first shoulder main groove 12 and a second shoulder main groove 13 that are provided in the tread surface 7, sandwich the center main groove 11 in the axial direction A1, and extend over the entire circumference in the circumferential direction C1. The center main groove 11 partially overlaps with a tire equatorial plane CL, that is, a plane orthogonal to the rotation axis of the tire 1 and passing through the center in the axial direction A1 of the tire 1. The first shoulder main groove 12 and the second shoulder main groove 13 are arranged substantially plane-symmetrically with respect to the tire equatorial plane CL. The first shoulder main groove 12 and the second shoulder main groove 13 are spaced apart in the axial direction A1 from the center main groove 11, and a region between the first shoulder main groove 12 and the second shoulder main groove 13 is referred to as an axial center region 16.

The center main groove 11, the first shoulder main groove 12, and the second shoulder main groove 13 are main grooves that meander in a zigzag manner, and the center main groove 11 has a larger groove amplitude in the axial direction A1 than the first shoulder main groove 12 and the second shoulder main groove 13. The tread surface 7 further includes a first circumferential groove 14 provided between the center main groove 11 and the first shoulder main groove 12 in the axial direction A1 and extending over the entire circumference in the circumferential direction C1, and a second circumferential groove 15 provided between the center main groove 11 and the second shoulder main groove 13 in the axial direction A1 and extending over the entire circumference in the circumferential direction C1.

The first circumferential groove 14 and the second circumferential groove 15 are arranged substantially plane-symmetrically with respect to the tire equatorial plane CL. The first circumferential groove 14 is spaced apart in the axial direction A1 from the center main groove 11 and the first shoulder main groove 12. The second circumferential groove 15 is spaced apart in the axial direction A1 from the center main groove 11 and the second shoulder main groove 13. The first circumferential groove 14 and the second circumferential groove 15 are sub-grooves that mender in a zigzag manner, and the groove amplitude in the axial direction A1 of the first circumferential groove 14 and the second circumferential groove 15 is substantially equal to the groove amplitude in the axial direction A1 of the first shoulder main groove 12 and the second shoulder main groove 13.

### Structure of Center Block Lines

In the present embodiment, the center blocks provided in the axial center region 16 are divided into small blocks, and the small blocks arranged at a high density. By arranging the small blocks, the number of edge elements increases and slippage is suppressed. Furthermore, by arranging the blocks at a high density in the axial center region 16 that is subjected to a high ground contact pressure, the force acting on the axial center region 16 is dispersed. As a result, the wear resistance is improved.

The tread pattern 8 has four block lines extending in the circumferential direction C in the axial center region 16. The four block lines include a first inner center block line 21, a second inner center block line 22, a first outer center block line 23, and a second outer center block line 24.

The first inner center block line 21 and the second inner center block line 22 are disposed at the center of a tread width TW1 and are adjacent to each other in the axial direction A1. The center main groove 11 is formed between the first inner center block line 21 and the second inner center block line 22.

The first outer center block line 23 is disposed adjacent to, and outward of, the first inner center block line 21 in the axial direction A1. The first outer center block line 23 and the first inner center block line 21 have the first circumferential groove 14 formed therebetween.

The second outer center block line 24 is disposed adjacent to, and outward of, the second inner center block line 22 in the axial direction A1. The second circumferential groove 15 is formed between the second outer center block line 24 and the second inner center block line 22.

The width of the center main groove 11 is 2.0% or more and 6.0% or less, and preferably 2.8% or more and 3.6% or less of the tread width TW1.

The width of the first circumferential groove 14 and the width of the second circumferential groove 15 are narrower than the width of the center main groove 11, and are each 30% or more and 80% or less of the width of the center main groove 11. The width of the first circumferential groove 14 and the width of the second circumferential groove 15 are each 1.0% or more and 4.0% or less of the tread width TW1.

The width of the first circumferential groove 14 and the width of the second circumferential groove 15 are narrower than the width of the first shoulder main groove 12 and the width of the second shoulder main groove 13, and are each 30% or more and 80% or less of the width of the first shoulder main groove 12 and the width of the second shoulder main groove 13.

Since the first circumferential groove 14 and the second circumferential groove 15 are formed to have the narrow widths described above, the blocks are divided into small blocks. As a result, the number of edges increases, thereby allowing for an increase in the traction and suppression of lateral slippage. On the other hand, the small blocks are easily moved, and thus uneven wear is likely to occur. To address this, the first circumferential groove 14 and the second circumferential groove 15 are made narrow and each have a smaller width than the center main groove 11, the first shoulder main groove 12, and the second shoulder main groove 13, so that when a peripheral region of the first circumferential groove 14 and a peripheral region of the second circumferential groove 15 of the tire 1 come into contact with the ground, land portions on opposite sides in the axial direction A1 of the first circumferential groove 14 and land portions on opposite sides in the axial direction A1 of the second circumferential groove 15 easily come into tight contact with each other, respectively, whereby pseudo large blocks are likely to be formed. Thus, the rigidity of the tire 1 increases, so that satisfactory wear resistance is likely to be achieved.

The depths of the center main groove 11, the first circumferential groove 14, and the second circumferential groove 15 are substantially equal to each other.

The first inner center block line 21 is disposed between the center main groove 11 and the first circumferential groove 14. The axial length of the first inner center block line 21 repeatedly increases and decreases in the circumferential direction C1. The first inner center block line 21 includes first blocks 21A and second blocks 21B that alternate with each other in the circumferential direction C1.

The second inner center block line 22 is disposed between the center main groove 11 and the second circumferential groove 15. The axial length of the second inner center block line 22 repeatedly increases and decreases in the circumferential direction C1. The second inner center block line 22 includes third blocks 22A and fourth blocks 22B that alternate with each other in the circumferential direction C1.

The first outer center block line 23 is disposed between the first circumferential groove 14 and the first shoulder main groove 12. The axial length of the first outer center block line 23 repeatedly increases and decreases in the circumferential direction C1. The first outer center block line 23 includes fifth blocks 23A and sixth blocks 23B that alternate with each other in the circumferential direction C1.

The second outer center block line 24 is disposed between the second circumferential groove 15 and the second shoulder main groove 13. The axial length of the second outer center block line 24 repeatedly increases and decreases in the circumferential direction C1. The second outer center block line 24 includes seventh blocks 24A and eighth blocks 24B that alternate with each other in the circumferential direction C1.

### Detailed Description of First and Second Blocks

A first slit 31 (first groove) is provided between each first block 21A and the adjacent second block 21B that is closer to a first side (upper side in FIGS. 2 and 3) in the circumferential direction C1. Each first slit 31 extends in the axial direction A1 and communicates with both the center main groove 11 and the first circumferential groove 14. Further, a first sipe 41 (second groove) is provided between each first block 21A and the adjacent second block 21B that is closer to a second side (lower side in FIGS. 2 and 3) in the circumferential direction C1. Each first sipe 41 extends in the axial direction A1 and communicates with both the center main groove 11 and the first circumferential groove 14.

As illustrated in FIG. 3, each first slit 31 is provided in a minimum axial length portion 21C of the first inner center block line 21: in other words, each first slit 31 constitutes a spacing between the adjacent blocks having the minimum axial length portion 21C interposed therebetween in the circumferential direction C1. As illustrated in FIG. 3, each first sipe 41 is provided in a maximum axial length portion 21D of the first inner center block line 21: in other words, each first sipe 41 constitutes a spacing between the adjacent blocks having the maximum axial length portion 21D interposed therebetween in the circumferential direction C1.

The first slits 31 and the first sipes 41 alternate with each other in the circumferential direction C1. The multiple first slits 31 are provided at substantially equal intervals in the circumferential direction C1, and the multiple first sipes 41 are also provided at substantially equal intervals in the circumferential direction C1. Each first sipe 41 is provided substantially at the center in the circumferential direction C1 between corresponding two first slits 31 adjacent to each other in the circumferential direction C1. By alternately providing the first slits 31 and the first sipes 41 in the circumferential direction C1 as described above, it is possible to balance traction performance and uneven wear resistance that are in a trade-off relationship, and to achieve both sufficient traction performance and satisfactory uneven wear resistance.

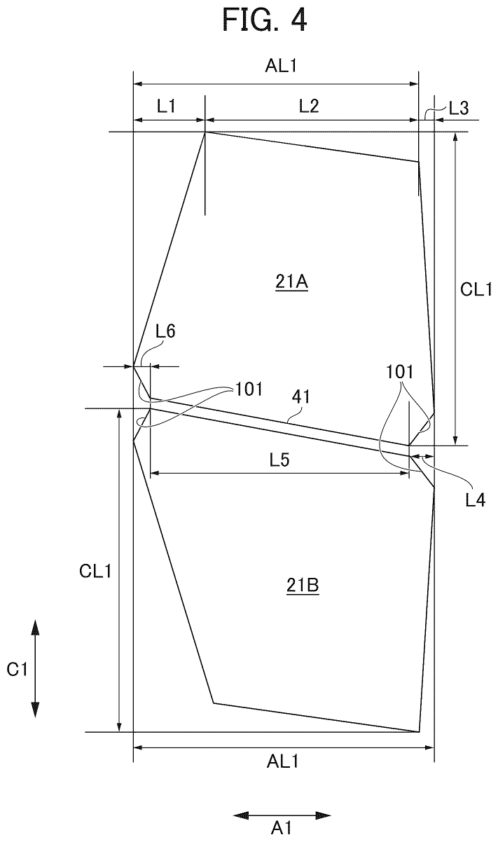

The shapes of the first block 21A and the second block 21B will be described with reference to FIG. 4. FIG. 4 is a plan view of the first block 21A and the second block 21B. The first block 21A and the second block 21B have a substantially trapezoidal shape. As illustrated in FIG. 4, the circumferential length (maximum length) CL1 of the first block 21A and the second block 21B is longer than the axial length (maximum length) AL1. In the present embodiment, in order that the traction performance that is required for an all-weather tire due to its nature is achieved in a center portion that is subjected to a high ground contact pressure, the number of traction elements (edges and corners pertaining to the multiple grooves, slits, and sipes) is increased by arranging the small blocks. On the other hand, the traction involves a force acting in the front-rear direction (circumferential direction C1). Therefore, in a case where the blocks have a shorter length in the circumferential direction than the axial direction, the blocks are easily moved in the front-rear direction, which causes uneven wear. To address this, each block of the present embodiment is configured such that its circumferential length CL1 is longer than its maximum axial length AL1, thereby reducing the likelihood of the occurrence of uneven wear. As a result, the traction performance and the uneven wear resistance can be appropriately improved.

For the first blocks 21A and the second blocks 21B, the position of the axial maximum length AL1 changes in the circumferential direction C1 depending on the presence or absence, the position, the size, the angle, and the like of chamfered portions 101 (described later).

The circumferential length CL1 is 1.01% or more and 1.50% or less, and preferably 1.01% or more and 1.25% or less of the axial length AL1, for the following reason. If the circumferential length CL1 is less than 1.01%, the blocks will be easily deformed due to a force acting in the front-rear direction at the time of driving and will be likely to cause uneven wear. If the circumferential length CL1 is more than 1.50%, the blocks will become long in the circumferential direction and will be likely to cause deterioration of the traction performance.

Block corner portions of each first block 21A and each second block 21B in the maximum axial length portion 21D (near the ends of the first sipe 41) are formed as chamfered portions 101.

The width of the first slit 31 is 5% or more and 20% or less of the circumferential length CL1 (FIG. 4) of the first block 21A and the second block 21B. Forming the first slit 31 to have a width of 5% or more of the circumferential length CL1 of the first block 21A allows the edges to function more effectively in comparison with a case where a sipe is formed, and achieves satisfactory traction performance. Forming the first slit 31 to have a width of 20% or less of the circumferential length CL1 of the first block 21A makes it easy to form the blocks in a size allowing for achieving a moderate rigidity and facilitates achievement of satisfactory wear resistance. The width of the first slit 31 exceeds 1.5 mm, for example.

The depth of the first slit 31 is 10% or more and 40% or less of the depth of the center main groove 11. In the case where the depth of the first slit 31 is 10% or more of the depth of the center main groove 11, satisfactory traction performance is likely to be exhibited. In the case where the depth of the first slit 31 is 40% or less of the depth of the center main groove 11, the rigidity can be ensured, so that the movement of the blocks is restricted and uneven wear is less likely to occur.

The sum of the depth of the first slit 31 and the depth of a first groove-bottom sipe 31A (described later) is 60% or more and 90% or less of the depth of the center main groove 11.

The width of the first sipe 41 is 0.5% or more and 5.0% or less of the circumferential length CL1 (FIG. 4) of the first block 21A and the second block 21B. The width of the first sipe 41 is 1.5 mm or less, for example. The width of the first sipe 41 is narrower than that of the first slit 31. Therefore, when the first block 21A and the second block 21B are deformed, the first sipe 41 is closed so that the rigidity of the first block 21A and the second block 21B is ensured.

The maximum depth of the first sipe 41 is 60% or more and 90% or less of the depth of the center main groove 11.

The depth of the first sipe 41 is shallower in opposite end portions than in the intermediate portion, and the depth in the opposite end portions is 10% or more and 50% or less, and preferably 20% or more and 40% or less of the maximum depth of the first sipe 41.

### Detailed Description of Third and Fourth Blocks

A second slit 32 (first groove) is provided between each third block 22A and the adjacent fourth block 22B that is closer to the first side (upper side in FIGS. 2 and 3) in the circumferential direction C1. Each second slit 32 extends in the axial direction A1 and communicates with both the center main groove 11 and the second circumferential groove 15. Further, a second sipe 42 (second groove) is provided between each third block 22A and the adjacent fourth block 22B that is closer to the second side (lower side in FIGS. 2 and 3) in the circumferential direction C1. Each second sipe 42 extends in the axial direction A1 and communicates with both the center main groove 11 and the second circumferential groove 15.

As illustrated in FIG. 3, each second slit 32 is provided in a minimum axial length portion 22C of the second inner center block line 22: in other words, each second slit 32 constitutes a spacing between the adjacent blocks having the minimum axial length portion 22C interposed therebetween in the circumferential direction C1. As illustrated in FIG. 3, each second sipe 42 is provided in a maximum axial length portion 22D of the second inner center block line 22: in other words, each second sipe 42 constitutes a spacing between the adjacent blocks having the maximum axial length portion 22D interposed therebetween in the circumferential direction C1.

The second slits 32 and the second sipes 42 alternate with each other in the circumferential direction C1. The multiple second slits 32 are provided at substantially equal intervals in the circumferential direction C1, and the multiple second sipes 42 are also provided at substantially equal intervals in the circumferential direction C1. Each second sipe 42 is provided substantially at the center in the circumferential direction C1 between corresponding two second slits 32 adjacent to each other in the circumferential direction C1. By alternately providing the second slits 32 and the second sipes 42 in the circumferential direction C1, it is possible to balance traction performance and uneven wear resistance, and to facilitate achievement of both sufficient traction performance and satisfactory uneven wear resistance.

As a result of the above-described configuration, the third blocks 22A and the fourth blocks 22B have a substantially trapezoidal shape. The third blocks 22A and the fourth blocks 22B also have the maximum circumferential length that is longer than the maximum axial length.

Block corner portions of each third block 22A and each fourth block 22B in the maximum axial length portion 22D (near the ends of the second sipe 42) are formed as chamfered portions 102.

The width and depth of the second slit 32 are equal to the width and depth of the first slit 31, respectively. The width and depth of the second sipe 42 are equal to the width and depth of the first sipe 41, respectively.

### Detailed Description of Fifth and Sixth blocks

A third slit 33 (first groove) is provided between each fifth block 23A and the adjacent sixth block 23B that is closer to the first side (upper side in FIGS. 2 and 3) in the circumferential direction C1. Each third slit 33 extends in the axial direction A1 and communicates with both the first circumferential groove 14 and the first shoulder main groove 12. In the bottom of each third slit 33, a third groove-bottom sipe 33A is formed. Further, a third sipe 43 (second groove) is provided between each fifth block 23A and the adjacent sixth block 23B that is closer to the second side (lower side in FIGS. 2 and 3) in the circumferential direction C1. Each third sipe 43 extends in the axial direction A1 and communicates with both the first circumferential groove 14 and the first shoulder main groove 12.

As illustrated in FIG. 3, each third slit 33 is provided in a minimum axial length portion 23C of the first outer center block line 23: in other words, each third slit 33 constitutes a spacing between the adjacent blocks having the minimum axial length portion 23C interposed therebetween in the circumferential direction C1. As illustrated in FIG. 3, each third sipe 43 is provided in a maximum axial length portion 23D of the first outer center block line 23: in other words, each third sipe 43 constitutes a spacing between the adjacent blocks having the maximum axial length portion 23D interposed therebetween in the circumferential direction C1.

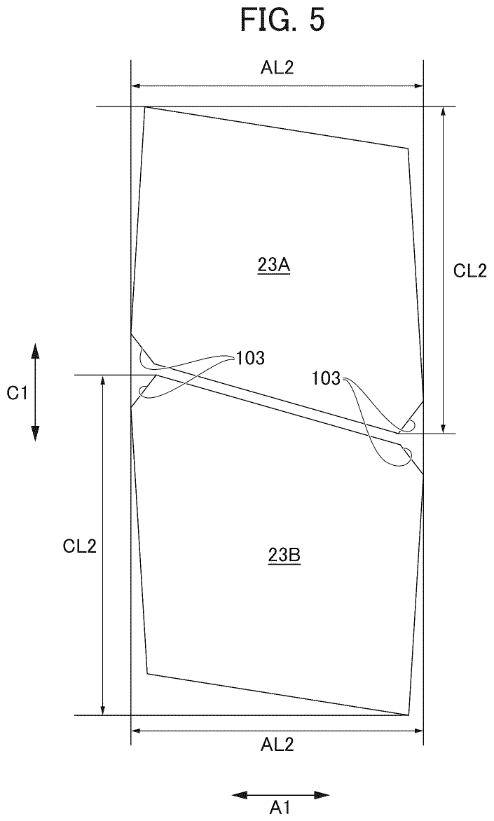

The shapes of the fifth block 23A and the sixth block 23B will be described with reference to FIG. 5. FIG. 5 is a plan view of the fifth block 23A and the sixth block 23B. The fifth block 23A and the sixth block 23B have a substantially trapezoidal shape.

As illustrated in FIG. 5, the fifth block 23A and the sixth block 23B have the maximum circumferential length CL2 that is longer than the maximum axial length AL2. In the present embodiment, in order that the traction performance that is required for an all-weather tire due to its nature is achieved in the center portion that is subjected to a high ground contact pressure, the number of traction elements is increased by arranging the small blocks. On the other hand, the traction involves a force acting in the front-rear direction (circumferential direction C1). Therefore, in a case where the blocks have a shorter length in the circumferential direction than the axial direction, the blocks are easily moved in the front-rear direction, which causes uneven wear. To address this, each block of the present embodiment is configured such that its maximum circumferential length is longer than its maximum axial length, thereby making it possible to appropriately improve the traction performance and the uneven wear resistance.

The circumferential length CL2 is 1.01% or more and 1.50% or less, and preferably 1.01% or more and 1.25% or less of the axial length AL2, for the following reason. If the circumferential length CL2 is less than 1.01%, the blocks will be easily deformed due to a force acting in the front-rear direction at the time of driving and will be likely to cause uneven wear. If the circumferential length CL2 is more than 1.50%, the blocks will become long in the circumferential direction and will be likely to cause deterioration of traction performance.

Block corner portions of each fifth block 23A and each sixth block 23B in the maximum axial length portion 23D (near the ends of the third sipe 43) are formed as chamfered portions 103.

The width and depth of the third slit 33 are equal to the width and depth of the first slit 31, respectively. The width and depth of the third sipe 43 are equal to the width and depth of the first sipe 41, respectively.

### Detailed Description of Seventh and Eighth Blocks

A fourth slit 34 (first groove) is provided between each seventh block 24A and the adjacent eighth block 24B that is closer to the first side (upper side in FIGS. 2 and 3) in the circumferential direction C1. Each fourth slit 34 extends in the axial direction A1 and communicates with both the second circumferential groove 15 and the second shoulder main groove 13. In the bottom of each fourth slit 34, a fourth groove-bottom sipe 34A is formed. Further, a fourth sipe 44 (second groove) is provided between each seventh block 24A and the adjacent eighth block 24B that is closer to the second side (lower side in FIGS. 2 and 3) in the circumferential direction C1. Each fourth sipe 44 extends in the axial direction A1 and communicates with both the second circumferential groove 15 and the second shoulder main groove 13.

As illustrated in FIG. 3, each fourth slit 34 is provided in a minimum axial length portion 24C of the second outer center block line 24: in other words, each fourth slit 34 constitutes a spacing between the adjacent blocks having the minimum axial length portion 24C interposed therebetween in the circumferential direction C1. As illustrated in FIG. 3, each fourth sipe 44 is provided in a maximum axial length portion 24D of the second outer center block line 24: in other words, each fourth sipe 44 constitutes a spacing between the adjacent blocks having the maximum axial length portion 24D interposed therebetween in the circumferential direction C1.

As a result of the above-described configuration, the seventh blocks 24A and the eighth blocks 24B have a substantially trapezoidal shape. The seventh blocks 24A and the eighth blocks 24B also have the maximum circumferential length that is longer than the maximum axial length.

Block corner portions of each seventh block 24A and each eighth block 24B in the maximum axial length portion 24D (near the ends of the fourth sipe 44) are formed as chamfered portions 104.

The width and depth of the fourth slit 34 are equal to the width and depth of the first slit 31, respectively. The width and depth of the fourth sipe 44 are equal to the width and depth of the first sipe 41, respectively.

### Relationship of Center Blocks Adjacent to Each Other in Axial Direction

The difference between the maximum axial length and the minimum axial length of the first and second blocks 21A and 21B is larger than the difference between the maximum axial length and the minimum axial length of the fifth and sixth blocks 23A and 23B. This is because the groove amplitude of the center main groove 11 is larger than that of the first circumferential groove 14.

The difference between the maximum axial length and the minimum axial length of the third and fourth blocks 22A and 22B is larger than the difference between the maximum axial length and the minimum axial length of the seventh and eighth blocks 24A and 24B. This is because the groove amplitude of the center main groove 11 is larger than that of the second circumferential groove 15.

The maximum axial length portions 21D of the first inner center block line 21 are adjacent to the minimum axial length portions 23C of the first outer center block line 23 in the axial direction A1, and the minimum axial length portions 21C of the first inner center block line 21 are adjacent to the maximum axial length portions 23D of the first outer center block line 23 in the axial direction A1. In more detail, the first sipes 41 of the first inner center block line 21 are adjacent to the third slits 33 of the first outer center block line 23 in the axial direction A1. More specifically, the axial centerline of each first sipe 41 and the axial centerline of the corresponding third slit 33 are located on substantially the same line. The first slits 31 of the first inner center block line 21 are adjacent to the third sipes 43 of the first outer center block line 23 in the axial direction A1. More specifically, the axial centerline of each first slit 31 and the axial centerline of the corresponding third sipe 43 are located on substantially the same line.

The maximum axial length portions 22D of the second inner center block line 22 are adjacent to the minimum axial length portions 24C of the second outer center block line 24 in the axial direction A1, and the minimum axial length portions 22C of the second inner center block line 22 are adjacent to the maximum axial length portions 24D of the second outer center block line 24 in the axial direction A1. In more detail, the second sipes 42 of the second inner center block line 22 are adjacent to the fourth slits 34 of the second outer center block line 24 in the axial direction A1. More specifically, the axial centerline of each second sipe 42 and the axial centerline of the corresponding fourth slit 34 are located on substantially the same line. The second slits 32 of the second inner center block line 22 are adjacent to the fourth sipes 44 of the second outer center block line 24 in the axial direction A1. More specifically, the axial centerline of each second slit 32 and the axial centerline of the corresponding fourth sipe 44 are located on substantially the same line.

The maximum axial length portions 21D of the first inner center block line 21 are adjacent to the minimum axial length portions 22C of the second inner center block line 22 in the axial direction A1, and the minimum axial length portions 21C of the first inner center block line 21 are adjacent to the maximum axial length portions 22D of the second inner center block line 22 in the axial direction A1. In more detail, the first sipes 41 of the first inner center block line 21 are adjacent to the second slits 32 of the second inner center block line 22 in the axial direction A1, and the first slits 31 of the first inner center block line 21 are adjacent to the second sipes 42 of the second inner center block line 22 in the axial direction A1.

Each fourth slit 34, the corresponding second sipe 42, the corresponding first slit 31, and the corresponding third sipe 43 are arranged on a first inclined line that is inclined with respect to the axial direction A1. The first inclined line extends in a direction in which the first inclined line is displaced toward one side (the lower side in FIGS. 2 and 3) in the circumferential direction C1 as it approaches one side (the right side in FIGS. 2 and 3) in the axial direction A1. The first inclined line is inclined at an angle of 5° or more and 25° or less with respect to the axial direction A1. Due to the above-described configuration, each fourth slit 34, the corresponding second sipe 42, the corresponding first slit 31, and the corresponding third sipe 43 can be sequentially, substantially continuously, and smoothly brought into contact with the ground from one side to the other side in the axial direction A1 when the tire fitted on a vehicle rotates, whereby continuous and sustainable traction can be efficiently generated for a long time.

Each fourth sipe 44, the corresponding second slit 32, the corresponding first sipe 41, and the corresponding third slit 33 are arranged on a second inclined line that is inclined with respect to the axial direction A1. The second inclined line extends in a direction in which the second inclined line is displaced toward one side (the lower side in FIGS. 2 and 3) in the circumferential direction C1 as it approaches one side (the right side in FIGS. 2 and 3) in the axial direction A1. The second inclined line is inclined at an angle of than 5° or more and 25° or less with respect to the axial direction A1. Due to the above-described configuration, each fourth sipe 44, the corresponding second slit 32, the corresponding first sipe 41, and the corresponding third slit 33 can be sequentially, substantially continuously, and smoothly brought into contact with the ground from one side to the other side in the axial direction A1 when the tire fitted on a vehicle rotates, whereby continuous and sustainable traction can be efficiently generated for a long time. As a result, the traction performance can be improved.

It should be noted that the first inclined line and the second inclined line may or may not be a straight line (including a substantially straight line). For example, the first inclined line and the second inclined line may include a curved portion and/or a bent portion.

### Shoulder Block Lines

The tread pattern 8 has a first shoulder block line 25 and a second shoulder block line 26. The first shoulder block line 25 is provided between the first outer center block line 23 and the first ground contact end 71. The second shoulder block line 26 is provided between the second outer center block line 24 and the second ground contact end 72.

The first shoulder block line 25 and the first outer center block line 23 have the first shoulder main groove 12 formed therebetween. The second shoulder block line 26 and the second outer center block line 24 have the second shoulder main groove 13 formed therebetween.

The width of the first shoulder block line 25 and the width of the second shoulder block line 26 are each 10% or more and 30% or less of the tread width TW1.

The first shoulder block line 25 is adjacent to the first shoulder main groove 12 in the axial direction A1. The axial length of the first shoulder block line 25 repeatedly increases and decreases in the circumferential direction C1.

The second shoulder block line 26 is adjacent to the second shoulder main groove 13 in the axial direction A1. The axial length of the second shoulder block line 26 repeatedly increases and decreases in the circumferential direction C1.

The first shoulder block line 25 includes a plurality of first shoulder blocks 25A arranged in the circumferential direction C1. Fifth slits 35 are formed between the first shoulder blocks 25A adjacent to each other in the circumferential direction C1. The fifth slits 35 extend in the axial direction A1 between the first shoulder main groove 12 and the first ground contact end 71.

The width of the fifth slit 35 is 3% or more and 15% or less of the circumferential length of the first shoulder block 25A. The depth of the fifth slit 35 is 10% or more and 40% or less of the depth of the center main groove 11.

Each fifth slit 35 is provided in a minimum axial length portion 35C of the first shoulder block line 25: in other words, each fifth slit 35 constitutes a spacing between the adjacent blocks having the minimum axial length portion 35C interposed therebetween in the circumferential direction C1. Each fifth slit 35 has a bent shape that is bent in its intermediate portion, and has a bent point 35A and a bent point 35B.

Each first shoulder block 25A has a fifth sipe 45. The fifth sipe 45 is provided in a maximum axial length portion 35D. An end of the fifth sipe 45 opposite to the first shoulder main groove 12 is closed within the first shoulder block 25A. That is, the fifth sipe 45 is a dead-end axial sipe that opens to the first shoulder main groove 12 and has the end closer to the first ground contact end 71 and closed within the block.

Each shoulder 3 of the tire 1 is likely to be affected by a lateral force. For example, when the tire 1 is turned, the shoulder 3 receives most of the lateral force applied to the tire 1. For this reason, the first shoulder blocks 25A are where uneven wear is likely to occur. In the present embodiment, because each first shoulder block 25A is not divided by the fifth sipe 45, the rigidity of the first shoulder block 25A can be increased, and uneven wear of the first shoulder block 25A can be effectively suppressed.

Each fifth sipe 45 has a bent shape that is bent in its intermediate portion in conformity with the bent shape of the first shoulder block 25A, and has a bent point 45A. In each first shoulder block 25A, block corner portions near one end of the fifth sipe 45 are formed as chamfered portions 105. By providing each fifth sipe 45 with edge elements in this manner, slippage is suppressed, whereby uneven wear resistance can be improved.

The width of the fifth sipe 45 is 1.5 mm or less, and the depth thereof is 5% or more and 30% or less, and preferably 10% or more and 20% or less of the depth of the center main groove 11.

The fifth slits 35 and the fifth sipes 45 alternate with each other in the circumferential direction C1. The multiple fifth slits 35 are provided at equal intervals in the circumferential direction C1, and the multiple fifth sipes 45 are also provided at equal intervals in the circumferential direction C1. Each fifth sipe 45 is provided substantially at the center in the circumferential direction C1 between corresponding two fifth slits 35 adjacent to each other in the circumferential direction C1.

The second shoulder block line 26 includes a plurality of second shoulder blocks 26A arranged in the circumferential direction C1. Sixth slits 36 extending in the axial direction A1 are formed between the second shoulder blocks 26A adjacent to each other in the circumferential direction C1. The sixth slits 36 extend in the axial direction A1 between the second shoulder main groove 13 and the second ground contact end 72.

The width of the sixth slit 36 is 3% or more and 15% or less, preferably 5% or more and 11% or less, and more preferably 6.8% or more and 7.3% or less of the circumferential length of the second shoulder block 26A. The depth of the sixth slit 36 is 10% or more and 40% or less, and preferably 20% or more and 30% or less of the depth of the center main groove 11.

Each sixth slit 36 is provided in a minimum axial length portion 36C of the second shoulder block line 26: in other words, each sixth slit 36 constitutes a spacing between the adjacent blocks having the minimum axial length portion 36C interposed therebetween in the circumferential direction C1. Each sixth slit 36 has a bent shape that is bent in its intermediate portion, and has a bent point 36A and a bent point 36B.

Each second shoulder block 26A has a sixth sipe 46. The sixth sipe 46 is provided in a maximum axial length portion 36D. The sixth sipe 46 is a dead-end axial sipe that opens to the second shoulder main groove 13 and has an end closer to the second ground contact end 72 and closed within the block. The sixth sipe 46 exerts the same effects as those of the fifth sipe 45.

Each sixth sipe 46 has a bent shape that is bent at its intermediate portion in conformity with the bent shape of the second shoulder block 26A, and has a bent point 46A. In each second shoulder block 26A, block corner portions near one end of the sixth sipe 46 are formed as chamfered portions 106.

The width and depth of the sixth sipe 46 are the same as the width and depth of the fifth sipe 45.

### Relationship between Shoulder Blocks and Center Blocks Adjacent to Each Other in Axial Direction

Each first shoulder block 25A is adjacent to the corresponding sixth and fifth blocks 23B and 23A in the axial direction A1. Each second shoulder block 26A is adjacent to the corresponding eighth and seventh blocks 24B and 24A in the axial direction A1. That is, one shoulder block is disposed corresponding to two center blocks.

The maximum axial length portions 35D of the first shoulder block line 25 are adjacent to the minimum axial length portion 23C of the first outer center block line 23 in the axial direction A1. In more detail, the fifth sipes 45 of the first shoulder block line 25 are adjacent to the third slits 33 of the first outer center block line 23 in the axial direction A1, and the fifth slits 35 of the first shoulder block line 25 are adjacent to the third sipes 43 of the first outer center block line 23 in the axial direction A1.

The maximum axial length portions 36D of the second shoulder block line 26 are adjacent to the minimum axial length portions 24C of the second outer center block line 24 in the axial direction A1. In more detail, the sixth sipes 46 of the second shoulder block line 26 are adjacent to the fourth slits 34 of the second outer center block line 24 in the axial direction A1, and the sixth slits 36 of the second shoulder block line 26 are adjacent to the fourth sipes 44 of the second outer center block line 24 in the axial direction A1.

The width of the first shoulder main groove 12 is 3.0% or more and 8.0% or less, preferably 3.3% or more and 6% or less, and more preferably 3.7% or more and 4.2% or less of the tread width TW1.

The width of the second shoulder main groove 13 is 3.0% or more and 8.0% or less, preferably 3.3% or more and 6% or less, and more preferably 3.7% or more and 4.2% or less of the tread width TW1.

### Shapes of Chamfered Portions

As described above, the end or ends of each sipe (communicating portion(s) through which the respective sipe communicates with the center main groove 11, the first shoulder main groove 12, the second shoulder main groove 13, the first circumferential groove 14, and/or the second circumferential groove 15) are provided with the chamfered portions 101, 102, 103, 104, 105 or 106 that have a substantially triangular shape widening toward the opening of the end. As illustrated in FIGS. 4 to 5, the chamfered portions 101 to 106 each have an opening angle of 90° or more and 120° or less.

In a case where a communicating portion through which a sipe communicates with a main groove or a sub groove has an acute angle, cracks are likely to form in the communicating portion of the sipe. In the present embodiment, since the chamfered portions 101 to 106 described above are provided, it is possible to reduce the likelihood of the concentration of strain on the communication portions, thereby enabling suppression of the occurrence of cracks.

### Shapes of Groove-Bottom Sipes

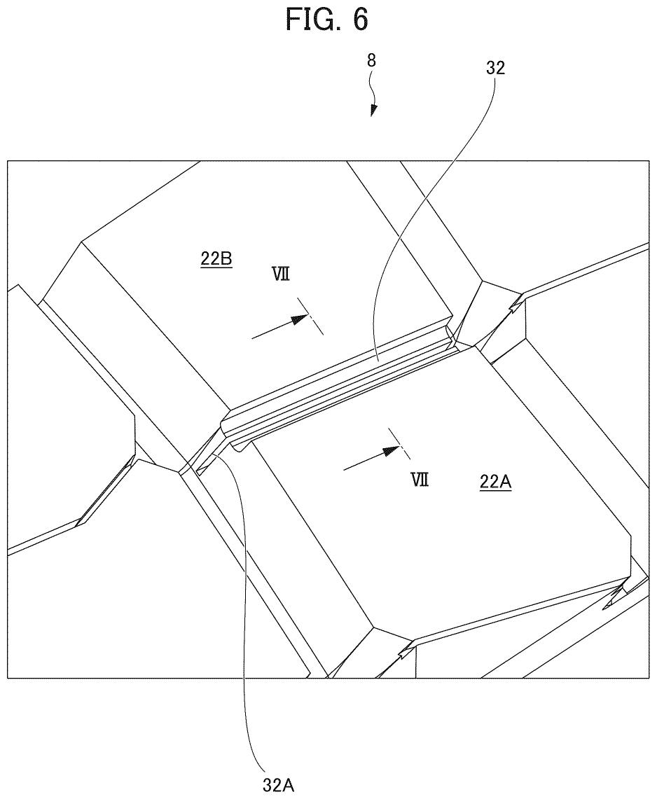

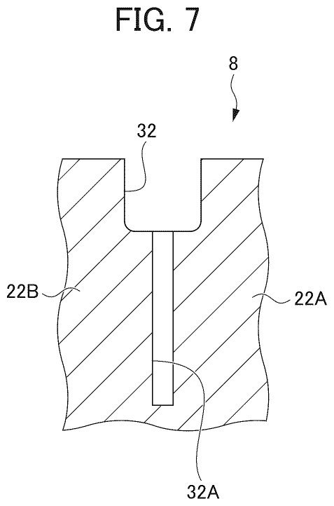

As illustrated in FIGS. 2 and 3, the first groove-bottom sipe 31A is formed in the bottom of each first slit 31, and the second groove-bottom sipe 32A is formed in the bottom of each second slit 32. FIG. 6 is a diagram for explaining the structure of the first groove-bottom sipe 31A and the second groove-bottom sipe 32A, and is an enlarged perspective view of a peripheral region of one second slit 32 in the tire 1 as viewed obliquely from above. FIG. 7 is a diagram for explaining the structure of the first groove-bottom sipe 31A and the second groove-bottom sipe 32A, and is a schematic cross-sectional view of a peripheral region of the second slit 32, taken along a plane substantially orthogonal to the extending direction of the second slit 32. As described above, since the first groove-bottom sipe 31A is formed in the bottom of each first slit 31, even if the first block 21A and the second block 21B are worn and the first slit 31 becomes shallower or lost, the traction performance is ensured by the first groove-bottom sipe 31A.

The structure of the first groove-bottom sipe 31A is substantially the same as the structure of the second groove-bottom sipe 32A. As illustrated in FIGS. 6 and 7, the first groove-bottom sipe 31A is formed in a central portion in the circumferential direction of the bottom of each first slit 31, and the second groove-bottom sipe 32A is formed in a central portion in the circumferential direction of the bottom of each second slit 32.

According to the tire 1 of the present embodiment, since the first groove-bottom sipe 31A and the second groove-bottom sipe 32A are respectively formed in the bottom of each first slit 31 and the bottom of each second slit 32, even if the depths of the first slit 31 and the second slit 32 become shallower than an appropriate depth, the traction performance can be maintained by the traction generated by the first groove-bottom sipe 31A and the second groove-bottom sipe 32A. Therefore, acceptable traction performance is easily maintained over a long period of time while uneven wear is suppressed. The third groove-bottom sipe 33A formed in the bottom of each third slit 33 and the fourth groove-bottom sipe 34A formed in the bottom of each fourth slit 34 have the same effect as described above.

### Detailed Description of Slits and Sipes along Second Inclined Line

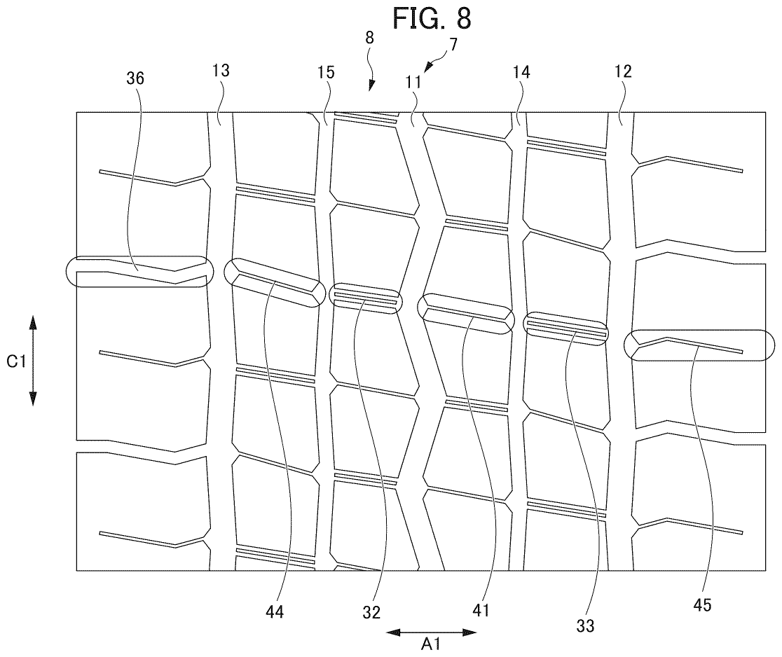

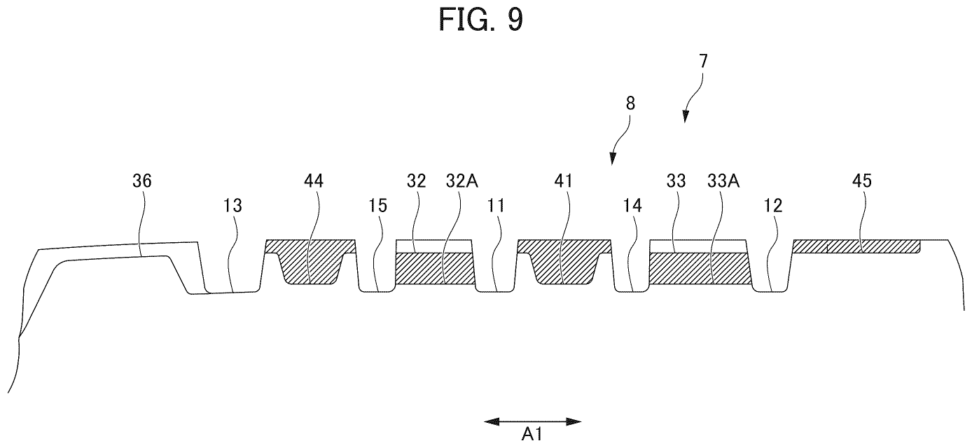

Next, cross-sectional shapes of the fourth sipe 44, the second slit 32, the first sipe 41, and the third slit 33 that are arranged along the second inclined line will be described with reference to FIGS. 8 and 9. FIG. 8 is a partial plan view of FIG. 3. FIG. 9 is a diagram illustrating cross-sectional structures of the sipes and slits marked with open ellipses in FIG. 8. In FIG. 9, regions where the sipes are provided are hatched.

As illustrated in FIG. 9, the first sipe 41 and the fourth sipe 44 are shallower in opposite end portions in the extending direction than the intermediate portion between the opposite end portions. The third groove-bottom sipe 33A and the second groove-bottom sipe 32A have a substantially constant depth in the extending direction of the corresponding third slit 33 and second slit 32. The bottom of the third groove-bottom sipe 33A and the bottom of the second groove-bottom sipe 32A are at substantially the same position as, or slightly outward in the radial direction of, the bottom of the first sipe 41 and the bottom of the fourth sipe 44.

The tire 1 of the present embodiment includes the center main groove 11, the first shoulder main groove 12, the second shoulder main groove 13, the first circumferential groove 14, the second circumferential groove 15, the first slits 31, and the first sipes 41, and therefore, an increased number of edge elements constituted of the edges and corners pertaining to the multiple grooves, slits, and sipes are provided, thereby facilitating enhancement of the traction.

### Traction Element

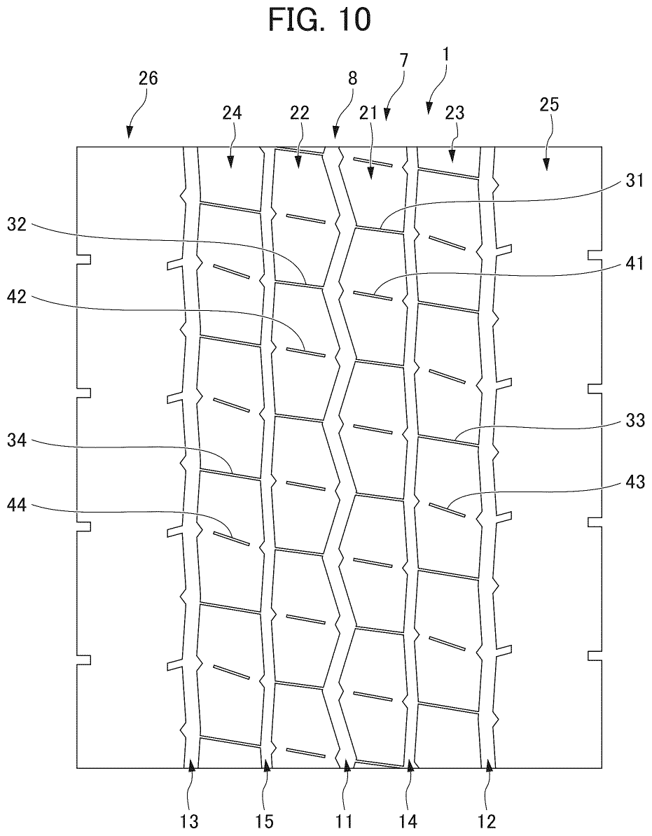

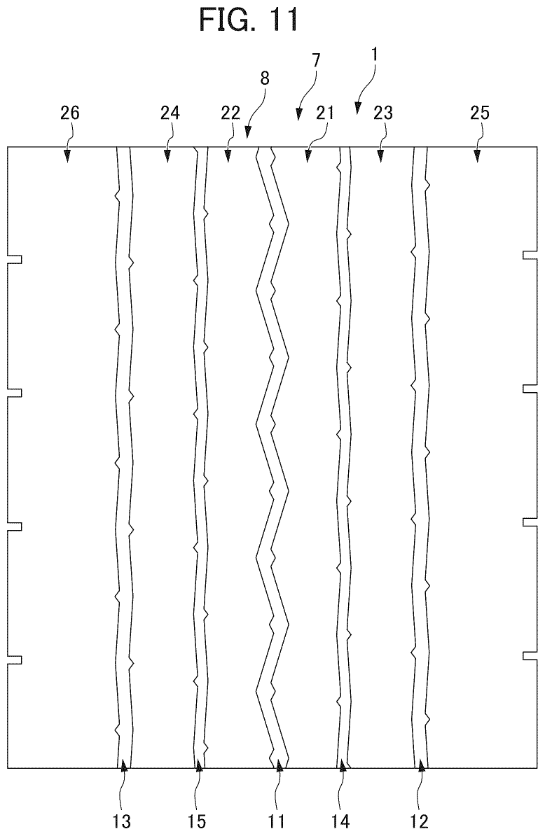

With reference to FIGS. 10 and 11, a change in a ratio of the total sum of traction element lengths in the axial center region 16 to the total sum of the areas of the center blocks (21A, 21B, 22A, 22B, 23A, 23B, 24A, 24B) (i.e., a traction element length per unit area) of the tire 1 of the present embodiment will be described. FIGS. 10 and 11 are schematic diagram illustrating changes in slits and sipes when tire is worn. The present embodiment is configured such that the foregoing ratio falls within the following specified range, whereby both traction and uneven wear resistance can be achieved.

In the present embodiment, the term “traction element length” means a length of an edge (block ridge line) of the block projected in the circumferential direction C1 and an element extending in the axial direction A1 (element having an axial component) of the sipe projected in the circumferential direction C1. The “total sum of traction element lengths” is a value obtained by adding the lengths of the traction elements of the entire circumference of the tire. In the example illustrated in FIG. 4, from among the edges of the first block 21A, the elements extending in the axial direction A1 are projected in the circumferential direction C1 as projected lengths L1, L2, L3, L4, L5, and L6, and the traction element length of the first block 21A is the sum of the projected lengths L1 to L6.

When the tire is not yet in use, the land portions around the slits 31, 32, 33, and 34 and the sipes 41, 42, 43, and 44 are not worn as illustrated in FIG. 2. The ratio of the total sum of the traction element lengths to the total sum of the block areas when the tire 1 is new is 4.5% or more and 10.0% or less, and preferably 5.0% or more and 8.0% or less. In the case where the ratio is less than 4.5%, the number of traction elements is small, which tends to cause deterioration of the traction performance. In the case where the ratio is more than 10.0%, the number of traction elements is large and the rigidity is low, which tends to cause uneven wear.

As illustrated in FIG. 10, in a stage of wear in which wear of 25% or more and 80% or less has occurred from the tire surface with respect to the depth of the center main groove 11 defined as 100%, the land portions around the slits 31, 32, 33, and 34 and the sipes 41, 42, 43, and 44 are worn, and the ends of the sipes 41, 42, 43, and 44 are lost. In this stage of wear, the ratio of the total sum of the traction element lengths to the total sum of the block areas is 2.5% or more and 4.5% or less, and preferably 3.0% or more and 4.0% or less. In the case where the ratio is less than 2.5%, the number of traction elements is small, which tends to cause deterioration of the traction performance. In the case where the ratio is more than 4.5%, the number of traction elements is large and the rigidity is low, which tends to cause uneven wear. In this stage of wear, the fifth slits 35 and the fifth sipes 45 of the first shoulder blocks 25A and the sixth slits 36 and the sixth sipes 46 of the second shoulder blocks 26A are lost. As can be seen from the foregoing, the sipes are formed so that the initial image of the tread pattern is maintained until near a late stage of wear.

As illustrated in FIG. 11, in a stage of wear in which wear of 85% has occurred from the tire surface with respect to the depth of the center main groove 11 defined as 100%, the slits 31, 32, 33, and 34 and the sipes 41, 42, 43, and 44 are lost. In this stage of wear, the ratio of the total sum of the traction element lengths to the total sum of the block areas is 0.5% or more and 2.5% or less, and preferably 0.8% or more and 1.2% or less. In this stage, which is a late stage of wear, traction is not particularly necessary.

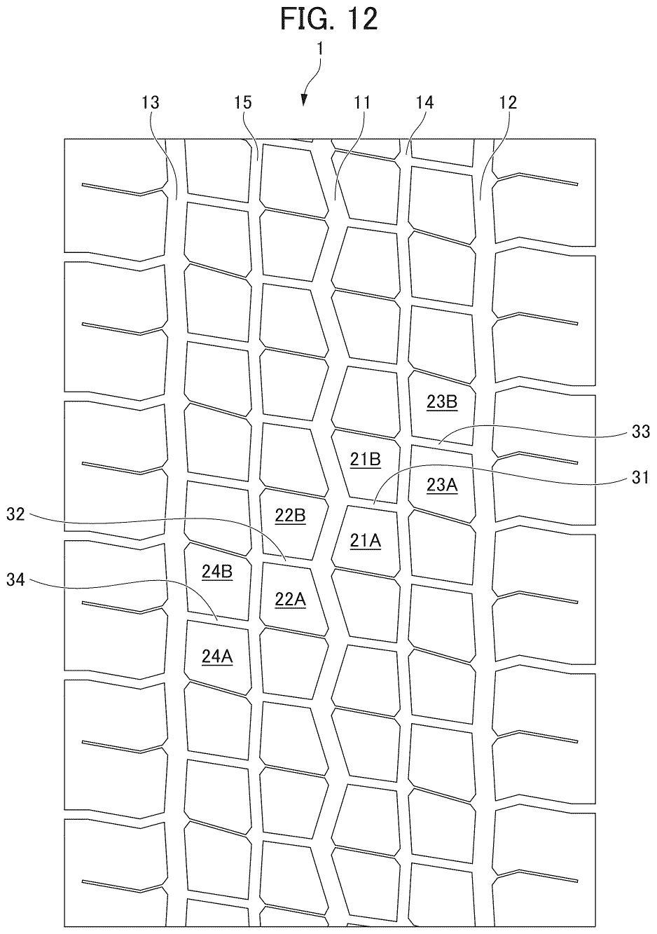

In the embodiment described above, the slits are provided with the groove-bottom sipes. However, the slits may not be provided with the groove-bottom sipes. In a pneumatic tire 1 according to another embodiment illustrated in FIG. 12, the bottoms of the first slits 31, the second slits 32, the third slits 33, and the fourth slits 34 are not provided with sipes.

### Aspects of the Embodiment

(1) The pneumatic tire 1 includes:
the center main groove 11 provided over the entire circumference in the circumferential direction C1;
the first shoulder main groove 12 and the second shoulder main groove 13 disposed so as to sandwich the center main groove 11 therebetween in the axial direction and provided over the entire circumference in the circumferential direction C1; and
the plurality of block lines 21, 22, 23, and 24 provided between the first shoulder main groove 12 and the second shoulder main groove 13 and extending in the circumferential direction C1. The plurality of block lines 21, 22, 23, and 24 respectively include the plurality of blocks 21A and 21B arranged in the circumferential direction C1, the plurality of blocks 22A and 22B arranged in the circumferential direction C1, the plurality of blocks 23A and 23B arranged in the circumferential direction C1, and the plurality of blocks 24A and 24B arranged in the circumferential direction C1, and
in a state where the pneumatic tire is new, a ratio of a total sum of traction element lengths to a total sum of block areas of the plurality of blocks 21A, 21B, 22A, 22B, 23A, 23B, 24A, and 24B is 4.5% or more and 10.0% or less.

Due to this feature, a pneumatic tire is produced which is capable of generating sufficient traction and has satisfactory uneven wear resistance by appropriately balancing improvement in traction performance and improvement in uneven wear resistance.

(2) In the pneumatic tire 1 according to (1), the traction element length is a length of an edge of each of the plurality of blocks 21A, 21B, 22A, 22B, 23A, 23B, 24A, and 24B projected in the circumferential direction C1.

Due to this feature, a pneumatic tire is produced which is capable of generating sufficient traction and has satisfactory uneven wear resistance by appropriately balancing improvement in traction performance and improvement in uneven wear resistance.

(3) The pneumatic tire 1 according to (1) or (2), in a stage of wear in which wear of 25% or more and 80% or less has occurred with respect to the depth of the center main groove 11 defined as 100%, the ratio of the total sum of the traction element lengths to the total sum of the block areas is 2.5% or more and 4.5% or less.

Due to this feature, a pneumatic tire is produced which is capable of generating sufficient traction and has satisfactory uneven wear resistance by appropriately balancing improvement in traction performance and improvement in uneven wear resistance.

(4) In the pneumatic tire 1 according to any one of (1) to (3), in a stage of wear in which wear of 85% has occurred with respect to the depth of the center main groove 11 defined as 100%, the ratio of the total sum of the traction element lengths to the total sum of the block areas is 0.5% or more and 2.5% or less.

Due to this feature, a pneumatic tire is produced which is capable of generating sufficient traction and has satisfactory uneven wear resistance by appropriately balancing improvement in traction performance and improvement in uneven wear resistance.

(5) The pneumatic tire 1 according to any one of (1) to (4) further includes the first grooves 31, 32, 33, and 34 and the second grooves 41, 42, 43, and 44 that are formed in the plurality of block lines 21, 22, 23, and 24, alternate with each other in the circumferential direction C1, and define the plurality of blocks 21A, 21B, 22A, 22B, 23A, 23B, 24A, and 24B.

Due to this feature, the blocks are densely arranged, so that the pneumatic tire has high wear resistance.

(6) In the pneumatic tire 1 according to (5), the first grooves 31, 32, 33, and 34 have the groove-bottom sipes 31A, 32A, 33A, and 34A formed in the groove bottom, respectively, and

the second grooves 41, 42, 43, and 44 have a smaller width than the first grooves 31, 32, 33, and 34.

Due to this feature in a case where the blocks 21A, 21B, 22A, 22B, 23A, 23B, 24A, and 24B are deformed, the second grooves 41, 42. 43, and 44 are closed so that the rigidity of the blocks 21A, 21B, 22A, 22B, 23A, 23B, 24A, and 24B is ensured.

### Other Embodiments

It should be noted that the present invention is not limited to the above-described embodiments, and various modifications can be made without departing from the spirit of the present invention. In particular, the embodiments and modifications described in the present specification can be arbitrarily combined as necessary.

What is claimed is:

1. A pneumatic tire, comprising:
a center main groove provided over an entire circumference in a circumferential direction;
a first shoulder main groove and a second shoulder main groove disposed so as to sandwich the center main groove therebetween in an axial direction and provided over the entire circumference in the circumferential direction; and
a plurality of block lines disposed between the first shoulder main groove and the second shoulder main groove and extending in the circumferential direction,
each of the plurality of block lines including a plurality of blocks arranged in the circumferential direction, wherein when the pneumatic tire is new, a ratio of a total sum of traction element lengths to a total sum of block areas of the plurality of blocks is 4.5% or more and 10.0% or less.

2. The pneumatic tire according to claim 1, wherein
the traction element length is a length of an edge of each of the plurality of blocks projected in the circumferential direction.

3. The pneumatic tire according to claim 1, wherein
when wear of 25% or more and 80% or less has occurred with respect to a depth of the center main groove defined as 100%, the ratio of the total sum of the traction element lengths to the total sum of the block areas is 2.5% or more and 4.5% or less.

4. The pneumatic tire according to claim 1, wherein
when wear of 85% has occurred with respect to a depth of the center main groove defined as 100%, the ratio of the total sum of the traction element lengths to the total sum of the block areas is 0.5% or more and 2.5% or less.

5. The pneumatic tire according to claim 1, further comprising:
first grooves and second grooves formed in each of the plurality of block lines, alternating with each other in the circumferential direction, and defining the plurality of blocks.

6. The pneumatic tire according to claim 5, wherein
each of the first grooves has a groove-bottom sipe formed in a groove bottom thereof, and
the second grooves have a smaller width than the first grooves.

7. The pneumatic tire according to claim 2, wherein
when wear of 25% or more and 80% or less has occurred with respect to a depth of the center main groove defined as 100%, the ratio of the total sum of the traction element lengths to the total sum of the block areas is 2.5% or more and 4.5% or less.

8. The pneumatic tire according to claim 2, wherein
when wear of 85% has occurred with respect to a depth of the center main groove defined as 100%, the ratio of the total sum of the traction element lengths to the total sum of the block areas is 0.5% or more and 2.5% or less.

9. The pneumatic tire according to claim 2, further comprising:
first grooves and second grooves formed in each of the plurality of block lines, alternating with each other in the circumferential direction, and defining the plurality of blocks.

10. The pneumatic tire according to claim 9, wherein
each of the first grooves has a groove-bottom sipe formed in a groove bottom thereof, and
the second grooves have a smaller width than the first grooves.

11. The pneumatic tire according to claim 2, wherein
when wear of 25% or more and 80% or less has occurred with respect to a depth of the center main groove defined as 100%, the ratio of the total sum of the traction element lengths to the total sum of the block areas is 2.5% or more and 4.5% or less.

12. The pneumatic tire according to claim 3, wherein
when wear of 85% has occurred with respect to a depth of the center main groove defined as 100%, the ratio of the total sum of the traction element lengths to the total sum of the block areas is 0.5% or more and 2.5% or less.

13. The pneumatic tire according to claim 3, further comprising:
first grooves and second grooves formed in each of the plurality of block lines, alternating with each other in the circumferential direction, and defining the plurality of blocks.

14. The pneumatic tire according to claim 13, wherein
each of the first grooves has a groove-bottom sipe formed in a groove bottom thereof, and
the second grooves have a smaller width than the first grooves.
